(19) United States
(12) Patent Application Publication
(10) Pub. No.: US 2026/0245404 A1
(43) Pub. Date: Aug. 20, 2026

(54) WORK MANAGEMENT DEVICE, WORK MANAGEMENT SYSTEM, WORK MANAGEMENT METHOD, AND RECORDING MEDIUM

(71) Applicant: NEC Corporation, Tokyo (JP)

(72) Inventors: Toru TAKAHASHI, Tokyo (JP); Yasunori Babazaki, Tokyo (JP); Takashi Shibata, Tokyo (JP)

(73) Assignee: NEC Corporation, Tokyo (JP)

(21) Appl. No.: 19/456,132

(22) Filed: Jan. 22, 2026

(30) Foreign Application Priority Data
Feb. 17, 2025 (JP) 2025-023220

(51) Int. Cl. G06V 40/20; G06V 20/40; G06V 20/52

(52) U.S. Cl. CPC G06V 40/20; G06V 20/41; G06V 20/52

(57) ABSTRACT

In the work management device, the video acquisition unit acquires video data obtained by capturing the work area where a plurality of workers exist. The information acquisition unit acquires object identification information that is acquired when a worker performs object identification work and identifies the target object of the work. The detection unit detects the work performed by each worker from the video data. Based on the object identification work included in the work detected from the video data, the management unit creates a work record in which the work performed on the object is associated with the object identification information of the object.

### INCORPORATION BY REFERENCE

This application is based upon and claims the benefit of priority from Japanese Patent Application 2025-023220, filed on February 17, 2025, the disclosure of which is incorporated herein in its entirety by reference.

### TECHNICAL FIELD

The present disclosure relates to a technique for managing work performed on objects.

### BACKGROUND ART

There have been proposed methods for managing work at a work site using a video captured by a camera. For example, JP2019-16226A discloses a system that classifies work performed by a worker into a plurality of processes based on video data of the work site and displays the processes.

### SUMMARY

In the system of JP2019-16226A, it is necessary to install a camera for each worker to capture fine movements of the worker, such as the position of the worker's hand, which makes the entire system expensive.

An object of the present disclosure is to provide a work management device capable of detecting and managing work performed on individual objects with a low-cost system configuration.

According to an example aspect of the present invention, there is provided a work management device comprising:
a video acquisition means configured to acquire video data obtained by capturing a work area in which a plurality of workers are present;
an information acquisition means configured to acquire object identification information for identifying an object on which work is performed, the object identification information being acquired by a worker performing object identification work;
a detection means configured to detect work performed by each worker from the video data; and
a management means configured to create a work record in which the work performed on the object is associated with the object identification information of the object, based on the object identification work included in the work detected from the video data.

According to another example aspect of the present invention, there is provided a work management method executed by a computer, comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data; and
creating a work record in which the work performed on the object is associated with the object identification information of the object, based on the object identification work included in the work detected from the video data.

According to still another example aspect of the present invention, there is provided a program that causes a computer to execute processing comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data; and
creating a work record in which the work performed on the object is associated with the object identification information of the object, based on the object identification work included in the work detected from the video data

According to the present disclosure, it is possible to detect and manage work performed on individual objects with a low-cost system configuration.

### BRIEF DESCRIPTION OF THE DRAWINGS

FIG. 1 schematically illustrates an outline of a work management system;

FIG. 2 is a block diagram illustrating a hardware configuration of a work management device;

FIG. 3 is a block diagram illustrating a functional configuration of the work management device;

FIG. 4 illustrates an example of a work record;

FIG. 5 illustrates an example of processing in a case where object identification work is simultaneously performed;

FIG. 6 illustrates information used in processing in a case where object identification work is simultaneously performed;

FIG. 7 is a flowchart of work record generation processing;

FIG. 8 illustrates a functional configuration of a work management device when the work record is displayed;

FIG. 9 illustrates a display example of the work record;

FIG. 10 is a flowchart of the work record display processing;

FIG. 11 is a block diagram illustrating a functional configuration of another work management device; and

FIG. 12 is a flowchart of processing by the other work management device.

### EXAMPLE EMBODIMENTS

### First example embodiment

### Schematic description

### Overall configuration

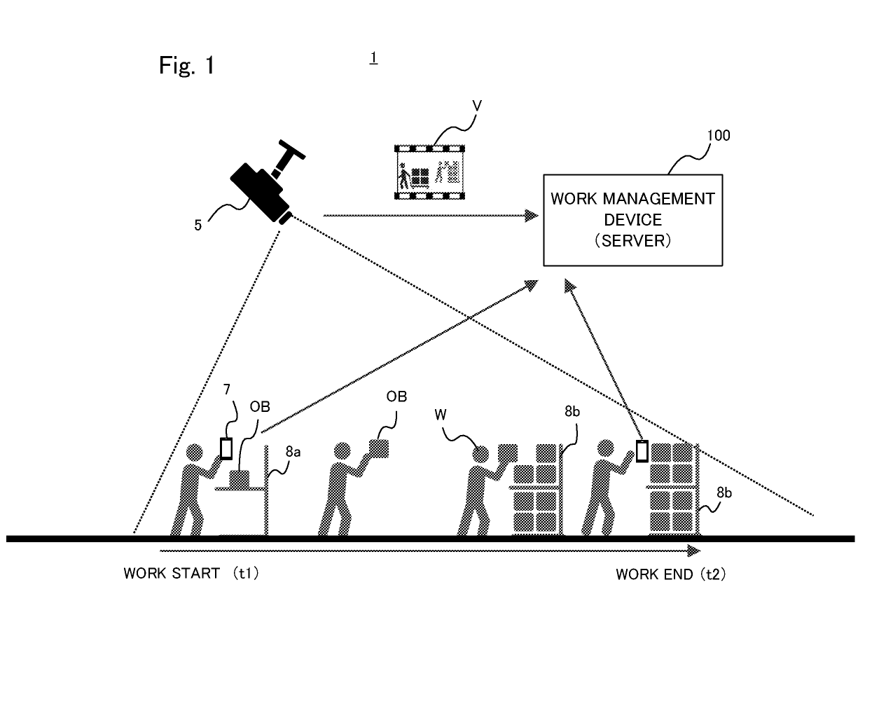

FIG. 1 schematically illustrates an outline of a work management system according to an example embodiment. The work management system is provided at a work site where a plurality of workers perform predetermined work. The work site is, for example, a manufacturing site of a product, a warehouse for distribution and storage of articles, a construction site, or the like. In the following description, the work site is assumed to be a logistics warehouse.

A work management system 1 includes a camera 5, terminals 7, and a work management device 100. The camera 5 is provided at a position to capture an area where a worker performs work (hereinafter referred to as a "work area") from a bird's- eye view. The entire work area may be captured by one camera 5, or the work area may be divided into several areas and captured by a plurality of cameras 5. FIG. 1 illustrates one camera 5 for convenience.

The terminals 7 are used by workers W to read object identification information from an object OB on which work is to be performed. The object identification information is identification information for uniquely identifying the object, and is, for example, a serial number of the object, a barcode indicating the serial number, a two-dimensional barcode, a QR code (registered trademark), an RFID storing the serial number, or an object fingerprint acquired from the object. Note that the "object fingerprint" refers to identification information extracted from an object based on the shape, characteristics, structure, and/or the like of the object. The terminal 7 is, for example, a smartphone or a dedicated reader having the function of a bar code reader, an RFID reader, a camera, or the like.

In a case where the worker W reads the object identification information from the object OB using the terminal 7, the terminal 7 transmits information (hereinafter referred to as "object identification work information") including the object identification information acquired from the object OB and the time when the object identification information was acquired (hereinafter referred to as "object identification time") to the work management device 100. The work of acquiring the object identification information from the object is referred to as "object identification work".

The work management device 100 includes a server or the like, and manages work by the workers. Specifically, the work management device 100 identifies the work performed on each object OB based on the video data captured by the camera 5 and the object identification work information received from the terminals 7, and stores the identified work in the work management device 100 in association with the object identification information of the objects OB. As a result, the work management device 100 can save a record (hereinafter referred to as a "work record") of what kind of work has been performed for each object OB.

### Operation example

Next, an operation example of the work management system 1 will be described. Now, it is assumed that a worker W performs work of moving the object OB from a shelf 8a to a shelf 8b as the intended work. FIG. 1 schematically illustrates a state in which the worker W moves the object OB. Note that "intended work" is work that each worker W is in charge of, and is work excluding object identification work among various types of work.

First, the worker W reads the object identification information from the object OB on the shelf 8a using the terminal 7. When the worker W reads the object identification information from the object OB using the terminal 7, the terminal 7 transmits the object identification work information including the object identification information read from the object OB and the object identification time, which is the time of reading the object identification information, to the work management device 100.

Next, the worker W moves the object OB to another shelf 8b, stores the object OB in the shelf 8b, and then reads the object identification information from the object OB again using the terminal 7. As a result, the terminal 7 transmits the object identification work information to the work management device 100.

In this manner, the worker W reads the object identification information from the object OB using the terminal 7 at the start and end of the intended moving work. As a result, the terminal 7 transmits the object identification work information including the object identification information and the object identification time to the work management device 100 at a work start time tl and a work end time t2.

On the other hand, the camera 5 transmits the video data V obtained by capturing the work area to the work management device 100. The work management device 100 recognizes the work performed by the worker from the video data V, and extracts object identification work from among the various types of recognized work. Then, the work management device 100 determines the time period between two object identification work performed on the same object OB, that is, between the object identification work at the start of the work and the object identification work at the end of the work as a work period, and acquires information (hereinafter also referred to as "video-based work information") such as the type of the work (work name) performed on the object OB during the work period and the work time (work start time and work end time) indicating when the work was performed.

Then, the work management device 100 compares the object identification time included in the object identification work information acquired from the terminal 7 with the work start time and the work end time included in the video-based work information, and if they match, generates a work record in which the work name and the object identification time (that matches the work time) are associated with the object identification information, and stores the work record in a database or the like.

The above operation is executed in parallel in an environment where a plurality of workers are performing their intended work on individual objects. Therefore, in an environment where a plurality of workers individually perform their intended work, the work management system 1 can distinguish, extract, and store the work performed on the individual objects based on the overhead image of the work area obtained from the camera 5. Therefore, it is not necessary to provide a camera, an information reading device, or the like for each worker or each object, and the entire system can be simplified and reduced in cost.

### Hardware configuration

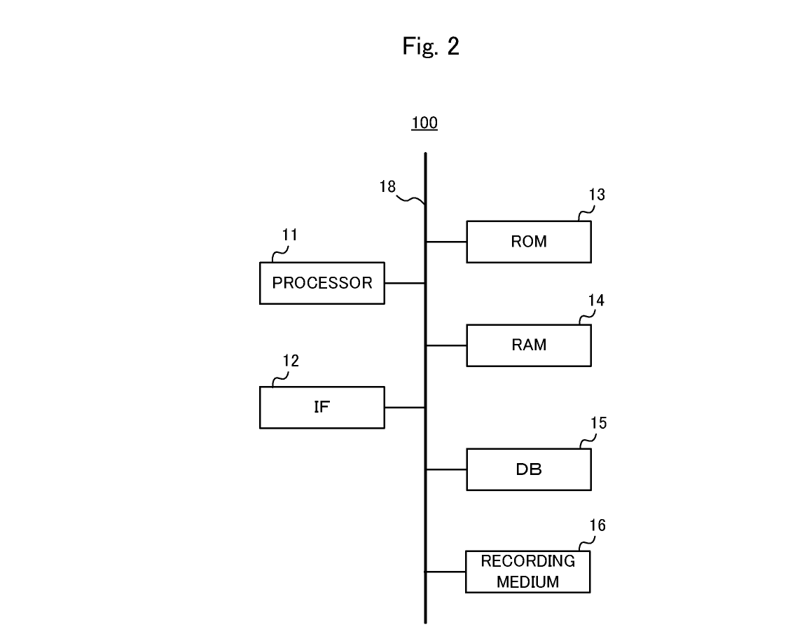

FIG. 2 is a block diagram illustrating a hardware configuration of the work management device 100. As illustrated, the work management device 100 includes a processor 11, an interface (IF) 12, a read only memory (ROM) 13, a random access memory (RAM) 14, a database (DB) 15, and a recording medium 16. The components are connected through, for example, a bus 18.

The processor 11 is a computer such as a central processing unit (CPU), and controls the work management device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

The processor 11 loads a program stored in the ROM 13 or the recording medium 16 into the RAM 14 and executes each type of processing coded in the program. The processor 11 functions as a part or all of the work management device 100. Specifically, the processor 11 executes work record generation processing and work record display processing to be described later.

The IF 12 transmits and receives data to and from an external device. Specifically, the work management device 100 receives the object identification work information from the terminal 7 through the IF 12. The work management device 100 receives video data from the camera 5 through the IF 12. In addition, the work management device 100 outputs a work record and video data related to the work record to an external device such as a display device through the IF 12.

The ROM 13 stores various programs executed by the processor 11. The RAM 14 is used as a working memory during execution of various types of processing by the processor 11.

The DB 15 stores various algorithms, data, machine learning models, and the like used when the work management device 100 executes the work record generation processing and work record display processing to be described later.

The recording medium 16 is a non-volatile non-transitory recording medium such as a disk-shaped recording medium or a semiconductor memory. The recording medium 16 may be attachable to and detachable from the work management device 100. The recording medium 16 records various programs executed by the processor 11.

In addition to the above, the work management device 100 may include a display device such as a liquid crystal display and an input device such as a keyboard and a mouse. The display device and the input device are used by, for example, an operator of the work management device 100.

### Functional configuration

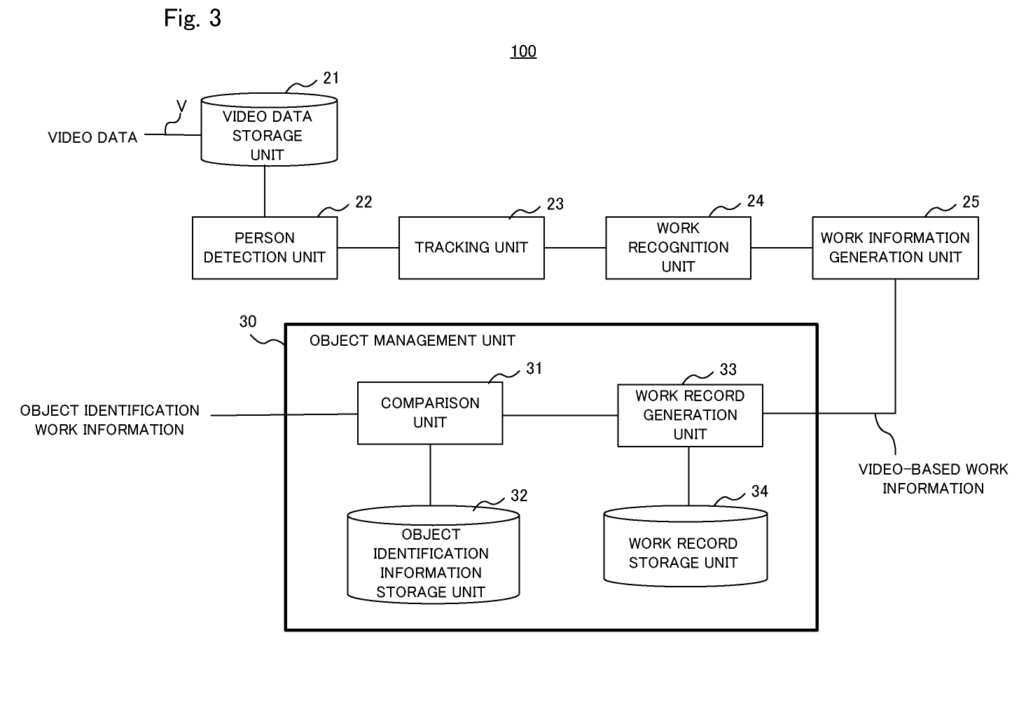

FIG. 3 is a block diagram illustrating a functional configuration of the work management device 100. As illustrated, the work management device 100 includes a video data storage unit 21, a person detection unit 22, a tracking unit 23, a work recognition unit 24, a work information generation unit 25, and an object management unit 30. The object management unit 30 includes a comparison unit 31, an object identification information storage unit 32, a work record generation unit 33, and a work record storage unit 34. The video data storage unit 21, the object identification information storage unit 32, and the work record storage unit 34 are implemented by the DB 15 illustrated in FIG. 2. In addition, the person detection unit 22, the tracking unit 23, the work recognition unit 24, the work information generation unit 25, the comparison unit 31, and the work record generation unit 33 are implemented by the processor 11 illustrated in FIG. 2.

The video data V captured by the camera 5 is stored in the video data storage unit 21. The person detection unit 22 detects a worker as a person from the video data V, and outputs the detection result to the tracking unit 23. The detection result of the worker may include a feature or an image of the worker. The tracking unit 23 tracks the detected worker in the video data V, and outputs a tracking result to the work recognition unit 24. The tracking result includes, for example, the position of the worker in each of the frame image constituting the video data V.

The work recognition unit 24 recognizes the work performed by the worker based on the tracking result of the worker, and outputs the work recognition result to the work information generation unit 25. For example, the work recognition unit 24 recognizes the work executed by a person from a video of the person including a plurality of frames using a pre-trained action recognition model or the like. For example, in a case where the work site is a logistics warehouse, the work recognition unit 24 recognizes work such as picking, packing, or moving as the intended work performed by the worker. Furthermore, the work recognition unit 24 recognizes the afore-mentioned object identification work as the work of the worker. That is, the work recognition unit 24 recognizes a work such as picking, packing, or moving as the intended work performed by the worker, and recognizes an object identification work, which is a work in which the worker reads the object identification information from the object.

The work information generation unit 25 extracts the object identification work performed by each worker from a plurality of work instances recognized by the work recognition unit 24. Specifically, the work information generation unit 25 acquires, for each worker, the time points when two consecutive object identification work instances, i.e., the time of the object identification work at the start of the work and the time of the object identification work at the end of the work. Then, the work information generation unit 25 determines the time period between the time of the object identification work at the start of the work (referred to as "work start time") and the time of the object identification work at the end of the work (referred to as "work end time") as one work period, and extracts the work performed by the worker in the work period. For example, in the example of FIG. 1, the work information generation unit 25 acquires the work start time tl and the work end time t2, and extracts "conveyance" as the work performed by the worker W in the work period between tl and t2. Then, the work information generation unit 25 outputs the extracted work name and the work time (the work start time and the work end time) to the work record generation unit 33 of the object management unit 30 as video-based work information. In this way, the work performed by each worker and the work time are extracted from the video data V and supplied to the work record generation unit 33.

On the other hand, the object identification work information is transmitted from the terminal 7 to the object management unit 30. The object identification work information includes object identification information read from the object by the worker and an object identification time indicating the time of reading object identification information. The object identification information storage unit 32 stores in advance the object identification information of each object and attribute information such as the type of the object. The comparison unit 31 compares the object identification information received from the terminal 7 with the object identification information stored in the object identification information storage unit 32, and determines whether the object identification information transmitted from the terminal 7 matches the object identification information registered in the object identification information storage unit 32, that is, whether or not the object read by the terminal 7 is the correct target of the work. In a case where the object identification information received from the terminal 7 matches the object identification information stored in the object identification information storage unit 32, the comparison unit 31 outputs the object identification work information to the work record generation unit 33. On the other hand, in a case where the object identification information received from the terminal 7 does not match the object identification information stored in the object identification information storage unit 32, since the object is not the correct target of the work, the comparison unit 31 excludes the object identification information from work record generation.

Thus, the work record generation unit 33 receives the video-based work information from the work information generation unit 25, and receives the object identification work information from the comparison unit 31. The work record generation unit 33 determines whether or not the work start time and the work end time included in the video-based work information match the start time and the end time of the object identification work included in the object identification work information, respectively. Note that the match in time here is assumed to allow for differences within a predetermined time error taking into account errors caused by, for example, the work recognition from the video data. In a case where there are matches in both the start time and the end time, the work record generation unit 33 determines that the object identification work information and the video-based work information correspond to each other, and stores the object identification work information and the video-based work information in the work record storage unit 34 as a work record. Specifically, the work record generation unit 33 stores the object identification time (which matches the work time) and the work name included in the video-based work information as a work record in association with the object identification information included in the object identification work information.

In the above configuration, the person detection unit 22 is an example of a video acquisition means and a detection means, the comparison unit 31 is an example of an information acquisition means, and the work record generation unit 33 is an example of a management means.

### Work record

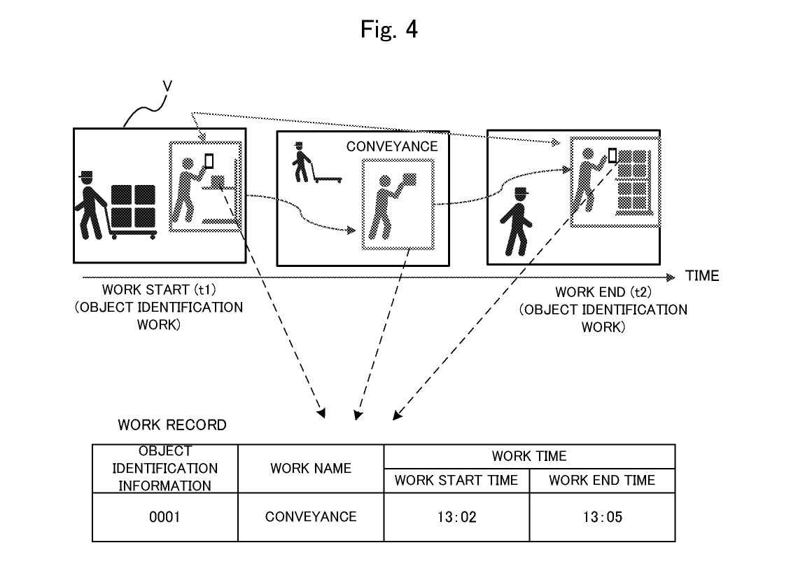

FIG. 4 illustrates an example of a work record. In this example, the object identification information of the object, the work name performed on the object, and the work time are saved as the work record. In the example of FIG. 4, the work start time and the work end time are stored as the work time, but instead of the work start time and the work end time, the time required for the work calculated from the work start time and the work end time may be stored, or both of them may be stored.

Further, the work record may include identification information of the worker. For example, in a case where the terminal 7 is distributed to each worker, identification information of the worker can be acquired from the terminal 7. In addition, face authentication or the like of the worker may be performed based on the video data to identify the worker.

Further, the work record may include the position information of the worker. For example, in a case where the terminal 7 is distributed to each worker, the position of the worker can be determined using a GPS function of the terminal 7. The terminal 7 may communicate with beacons distributed in the work area to determine the position of the worker, or the position of the worker may be determined using a Wi- Fi function of the terminal 7. Alternatively, the position of the worker may be determined by determining the position of the worker in a camera coordinate system based on the video data of the camera 5, and then converting the position into world coordinates corresponding to the entire work area.

### Processing when object identification work is simultaneously performed

Next, processing in a case where the object identification work is simultaneously performed by a plurality of workers will be described. As described above, in a case where the object identification time in the object identification work information matches the work time in the video-based work information, the work record generation unit 33 associates the object identification information in the object identification work information with the work name in the video data. However, in a case where a plurality of workers simultaneously perform the object identification work at the start of work and the object identification work at the end of work, the work record generation unit 33 cannot distinguish the work performed by each worker.

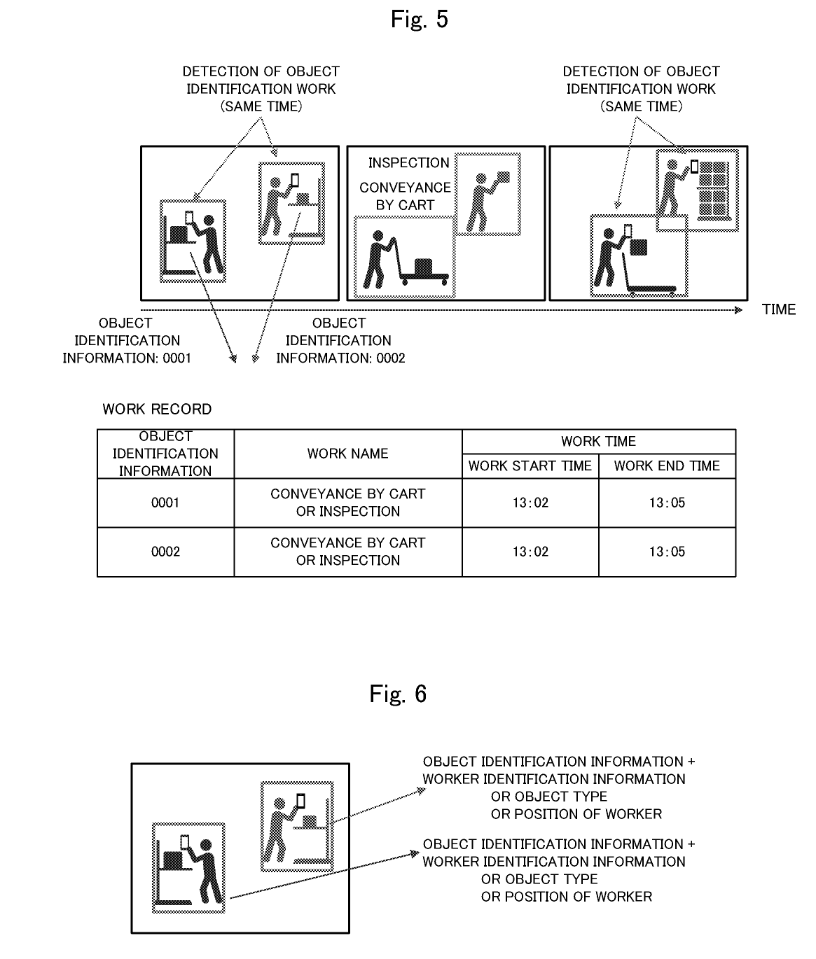

To address this, for example, the work record generation unit 33 generates a work record by associating each of a plurality of recognized work instances with the object identification information of the corresponding object. FIG. 5 illustrates an example of this case. As illustrated in FIG. 5, it is assumed that two workers simultaneously perform the object identification work at the start of work and the object identification work at the end of work. Here, it is assumed that one worker performs "conveyance using a cart" and the other worker performs "inspection." In this case, the work record generation unit 33 records both work instances, that is, "conveyance using a cart" and "inspection" for two pieces of object identification information. As a result, although it is not possible to distinguish the two work instances, it is possible to at least narrow down the possibilities to a plurality of possible work instances and present those work instances to the user.

As another approach, the work of each worker can be distinguished by using additional information by first to third methods described below. FIG. 6 illustrates information used to determine the work of each worker in a case where the object identification work is simultaneously performed by a plurality of workers.

In the first method, the work of each worker is determined using identification information of the worker. Specifically, the work management device 100 identifies the worker by face authentication or the like from the video of the worker in the video data, acquires the identification information of the worker, and outputs the identification information of the worker to the object management unit 30 by including the identification information of the worker in the video-based work information. On the other hand, the terminal 7 acquires the identification information of the worker from the identification information of the terminal and transmits the identification information of the worker to the object management unit 30 by including the identification information of the worker in the object identification work information. The work record generation unit 33 compares the identification information of the worker included in the video-based work information with the identification information of the worker included in the object identification work information to determine which work has been performed on each object, and generates work records.

In the second method, the work of each worker is determined using the type of each object. Specifically, the work management device 100 recognizes the type of the object captured in the video data together with the worker, and outputs the video- based work information including the type of the object to the object management unit 30. On the other hand, the comparison unit 31 acquires the type of the object from the object identification information storage unit 32 based on the object identification information. Then, the work record generation unit 33 compares the type of the object acquired from the object identification information storage unit 32 with the type of the object included in the video-based work information to determine which work has been performed on each object, and generates work records.

In the third method, the work of each worker is determined using the position of the worker. Specifically, the terminal 7 detects the position of the worker using the GPS or the like, and transmits object identification work information including the position to the work management device 100. On the other hand, the person detection unit 22 and the tracking unit 23 estimate the position of the worker from the video data, and the work information generation unit 25 outputs the video-based work information including the position of the worker to the work record generation unit 33. The work record generation unit 33 compares the position of the worker included in the object identification work information with the position of the worker included in the video-based work information to determine which work each of the two workers has performed, and generates work records.

### Work record generation processing

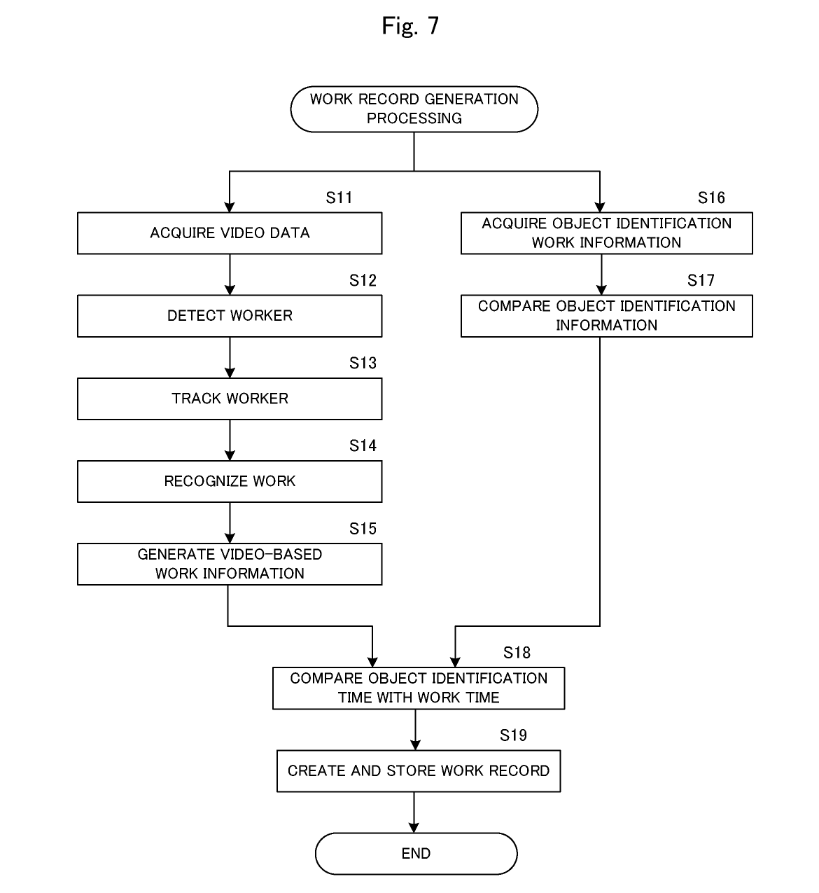

Next, the work record generation processing by the work management device 100 will be described. FIG. 7 is a flowchart of the work record generation processing. This processing is implemented by the processor 11 illustrated in FIG. 2 executing a program prepared in advance and operating as each element illustrated in FIG. 3.

First, the person detection unit 22 acquires the video data V from the video data storage unit 21 (step S l), and detects the worker from the video data (step S12). Next, the tracking unit 23 tracks the detected worker in the video data V (step S13). Next, the work recognition unit 24 recognizes the work performed by the worker based on the tracking result of the worker (step S14). Next, the work information generation unit 25 generates the video-based work information including the work name of the recognized work and the work time (step S 15).

On the other hand, when the worker reads the object identification information of the object, the comparison unit 31 of the object management unit 30 acquires the object identification work information transmitted from the terminal 7 (step S16), and compares the object identification information included in the object identification work information with the object identification information stored in the object identification information storage unit 32 (step S17). In a case where the object identification information included in the object identification work information is not stored in the object identification information storage unit 32, the processing ends.

Next, the work record generation unit 33 compares the object identification time included in the object identification work information with the work time included in the video-based work information, and determines whether or not the object identification time and the work time match (step S18). In a case where they match, the work record generation unit 33 generates a work record by associating the work name included in the video-based work information and the object identification time included in the object identification work information with the object identification information, and stores the work record in the work record storage unit 34 (step S19). Then, the work record generation processing ends.

### Display of work record

Next, processing of displaying the work record by the user will be described. When a problem or the like occurs with the object and the user wants to refer to the work record for the object, the user can specify the object and display the work record.

### Configuration of work management device

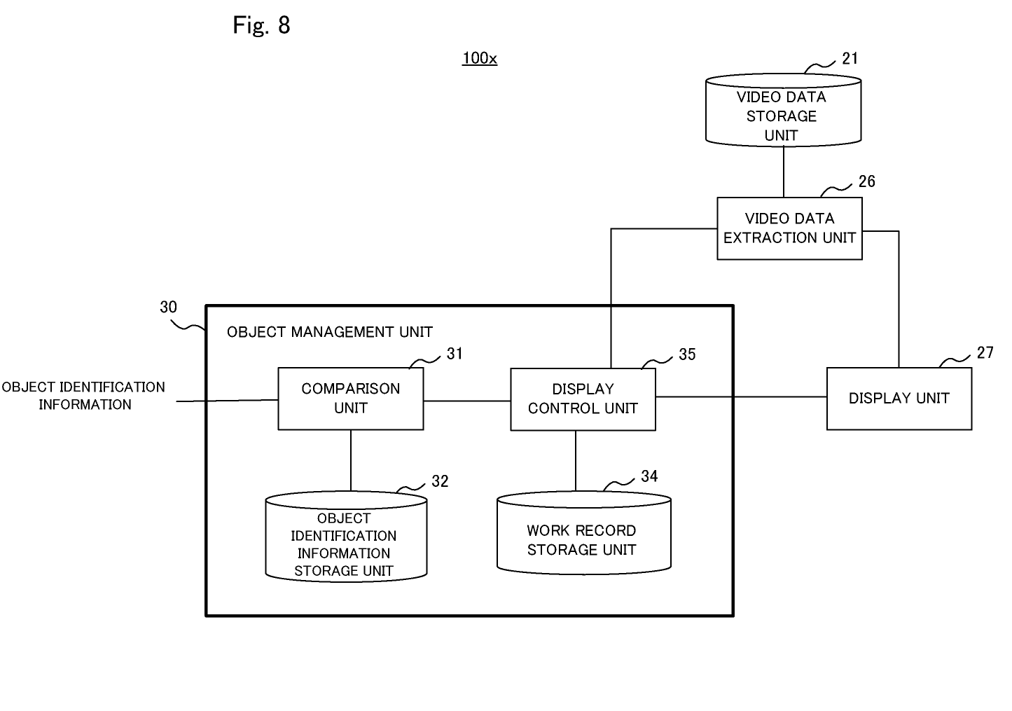

FIG. 8 illustrates a functional configuration of a work management device 100x which displays the work record. The work management device 100x includes the video data storage unit 21, a video data extraction unit 26, a display unit 27, and the object management unit 30. The object management unit 30 includes the comparison unit 31, the object identification information storage unit 32, the work record storage unit 34, and a display control unit 35. The video data storage unit 21, the comparison unit 31, the object identification information storage unit 32, and the work record storage unit 34 are similar to those in the work management device 100 illustrated in FIG. 3.

When the user wants to refer to the work record, the user inputs the object identification information of the object to the work management device 100x. The comparison unit 31 of the object management unit 30 compares the input object identification information with the object identification information stored in the object identification information storage unit 32. In a case where object identification information that matches the input object identification information does not exist in the object identification information storage unit 32, the object is not to be managed by the work management device 100x, and thus the work management device 100x ends the processing.

On the other hand, in a case where there is object identification information that matches the input object identification information in the object identification information storage unit 32, the comparison unit 31 outputs the object identification information to the display control unit 35. The display control unit 35 performs control for displaying the work record of the object corresponding to the input object identification information. Specifically, the display control unit 35 first reads the work record corresponding to the object identification information from the work record storage unit 34, generates a work history based on the work name and the work time included in the work record, and outputs the work history to the display unit 27.

In addition, the display control unit 35 can display statistical information or the like based on the work record in response to a request from the user. For example, the display control unit 35 may determine, based on the work record, whether or not a plurality of work instances have been performed in a correct order on a certain object, whether or not work has been performed on a certain object within a normal average work time, i.e., whether or not the work has not taken too long or too little time, and display the determination result.

In a case where the user requests display of the work video corresponding to the work in the work history, the display control unit 35 outputs the work name and the work period corresponding to the work time in the work record to the video data extraction unit 26. The video data extraction unit 26 extracts video data for the specified work period. That is, the video data extraction unit 26 cuts out a video for the work period from the video data V and displays the obtained video on the display unit 27 as the work video.

In the above configuration, the display control unit 35 is an example of a work record acquisition means and a work history output means, and the video data extraction unit 26 is an example of a video output means.

### Display example of work record

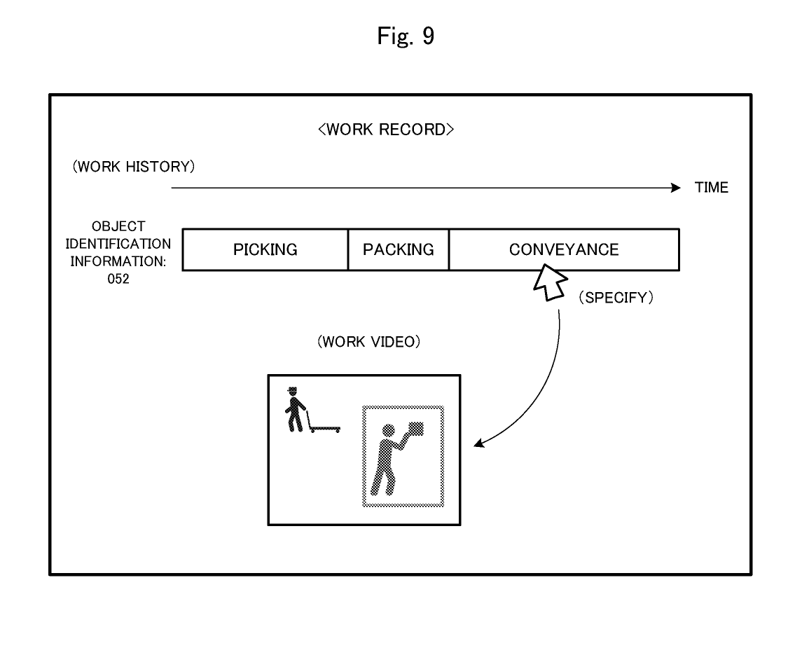

FIG. 9 illustrates a display example of the work record. In this example, the user has specified an object of the object identification information "052", and a work history for this object has been displayed. The work history indicates the work performed on the object in time series. When the user specifies certain work in the work history, a video for its work period is displayed as the work video. For example, in the example of FIG. 9, when the user clicks and specifies one of the work bars of "picking", "packing", and "conveyance" in the work history, the work management device 100x displays a work video corresponding to the specified work. In the example of FIG. 9, the user has specified "conveyance" as the work, and a work video during the work of conveying the object is displayed.

### Work record display processing

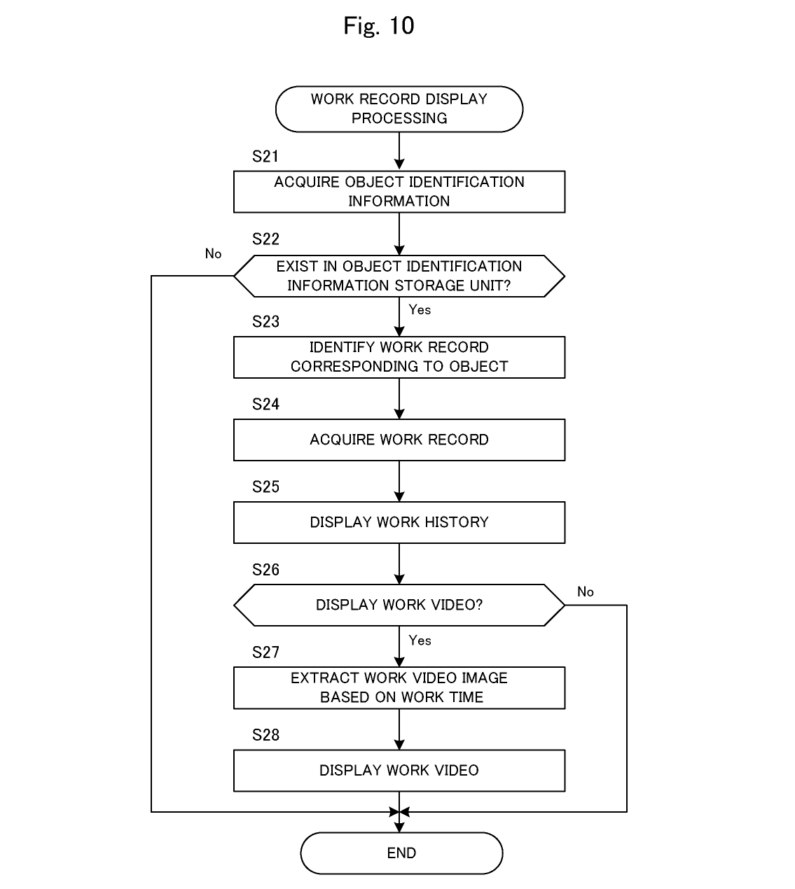

FIG. 10 is a flowchart of the work record display processing. This processing is implemented by the processor 11 illustrated in FIG. 2 executing a program prepared in advance and operating as each element illustrated in FIG. 8.

First, the user inputs the object identification information of the object of interest to the work management device 100x, and the work management device 100x acquires the input object identification information (step S21). Then, the comparison unit 31 compares the input object identification information with the object identification information stored in the object identification information storage unit 32 (step S22). In a case where the input object identification information does not exist in the object identification information storage unit 32 (step S22: No), there is no work record for the object corresponding to the object identification information input by the user, and thus the processing ends.

On the other hand, when the input object identification information exists in the object identification information storage unit 32 (step S22: Yes), the display control unit 35 identifies a work record corresponding to the input object identification information from the work record storage unit 34 (step S23), and acquires the work record (step S24). Next, the display control unit 35 creates a work history as exemplified in FIG. 9 from the work record and displays the work history on the display unit 27 (step S25).

Next, the work management device 100x determines whether or not there is a request to display the work video from the user (step S26). In a case where there is no request to display the work video (step S26: No), the processing ends. On the other hand, in a case where there is a request to display the work video (step S26: Yes), the display control unit 35 outputs the work time of the work specified by the user to the video data extraction unit 26. The video data extraction unit 26 extracts the work video corresponding to the input work time from the video data (step S27), and displays the work video on the display unit 27 (step S28). Then, the processing ends.

### Modifications

### First modification

In the above example embodiment, the work management device 100x for displaying a work record is described separately from the work management device 100 for generating the work record. However, in practice, a work management device may have both the functions of the work management device 100 and the work management device 100x.

### Second modification

In the above example embodiment, the object identification information is read from the object using the terminal 7 held by each worker. However, a dedicated terminal device such as a reader or a camera for reading the object identification information may be provided, and each worker may read the object identification information by sharing the terminal device.

### Application Example

Next, application examples of work management systems according to example embodiments will be described.

### (1) Work guarantee in manufacturing and distribution industries

The work management system can be used for work guarantee in the manufacturing and distribution industries. Specifically, the actual labor (actual work) performed in the manufacturing process of a product can be traced based on the object identification information (product ID or the like) of each product. In addition, when a defect or a defective product is found, it is possible to quickly determine at which stage in the process of product manufacturing or distributing the defect or defective product occurred. Furthermore, in response to a customer claim regarding a defect or defective product, a work record can be used to prove that the manufacturers and distributors involved in the product have operated appropriately.

### (2) Utilization in fair trade

Fair trade refers to a system or movement that promotes fair business practices by providing appropriate compensation to producers and workers in developing countries and supporting a sustainable livelihood. Fair trade aims to remedy economic inequalities and allow producers to lead a stable life. In this regard, by managing the actual labor (actual work) performed in the process of producing products in association with the products themselves using the work management system according to an example embodiment, it is possible to trace back from a finished article to verify that it was produced under appropriate labor practices. For example, a fair-trade certification organization can appropriately determine whether products should be certified by tracing, from the products, the manufacturing process of each product during the certification process.

### (3) Utilization in product branding

Branding of articles refers to a series of strategic activities that provide unique identities to articles and services and convey their value to consumers. The articles are clearly differentiated from other competing articles and are easily recognized by customers, thereby establishing a position as a brand that consumers choose. In this regard, it is possible to specify, from the final product, that a specific producer or manufacturer was involved in the production or manufacturing of the product by using the work management system of an example embodiment. When the manufacturing process can be known based on the work record, the manufacturers and workers involved in the manufacturing of the product can be known. For example, it is possible to indicate the brand value of a product by indicating that a specific famous or prominent manufacturer or worker is involved in the manufacturing. In addition, it is possible to appeal the value of the product by indicating that the product has undergone an inspection of a reliable inspection company, that the product has been certified by a certification organization accredited by the country, or the like, based on the work record.

### Second example embodiment

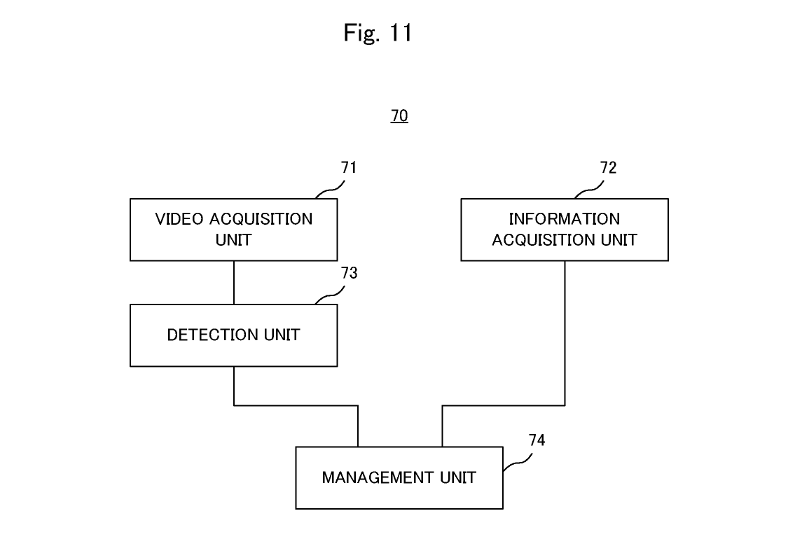

FIG. 11 is a block diagram illustrating a functional configuration of a work management device 70 according to another example embodiment of the present disclosure. The work management device 70 includes a video acquisition unit 71, an information acquisition unit 72, a detection unit 73, and a management unit 74.

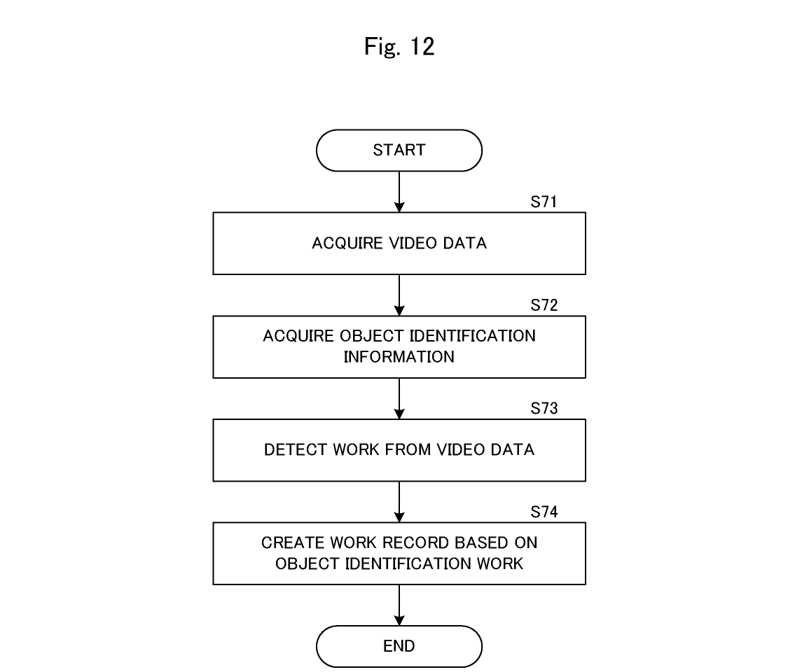

FIG. 12 is a flowchart of processing by the work management device 70. The video acquisition unit 71 acquires video data obtained by capturing the work area where a plurality of workers exist (step S71). The information acquisition unit 72 acquires object identification information that is acquired when a worker performs object identification work and identifies the target object of the work (step S72). The detection unit 73 detects the work performed by each worker from the video data (step S73). Based on the object identification work included in the work detected from the video data, the management unit 74 creates a work record in which the work performed on the object is associated with the object identification information of the object (step S74).

A part or all of the example embodiments described above may also be described as the following supplementary notes, but not limited thereto.

### Supplementary note 1

A work management device comprising:
a video acquisition means configured to acquire video data obtained by capturing a work area in which a plurality of workers are present;
an information acquisition means configured to acquire object identification information for identifying an object on which work is performed, the object identification information being acquired by a worker performing object identification work;
a detection means configured to detect work performed by each worker from the video data; and
a management means configured to create a work record in which the work performed on the object is associated with the object identification information of the object, based on the object identification work included in the work detected from the video data.

### Supplementary note 2

The work management device according to Supplementary note 1, wherein the management means associates, from the work detected from the video data, work performed on the object in a period between a start-time object identification work performed at a start of intended work on the object and an end-time object identification work performed at an end of the intended work with the object identification information of the object.

### Supplementary note 3

The work management device according to Supplementary note 2,
wherein the information acquisition means acquires a first object identification work time that is a time at which the worker performed the object identification work at the start of the intended work and a second object identification work time that is a time at which the worker performed the object identification work at the end of the intended work, and
wherein the management means associates a work performed on the object between the start-time object identification work performed at a time that matches the first object identification work time and the end-time object identification work performed at a time that matches the second object identification work time with the object identification information of the object.

### Supplementary note 4

The work management device according to any one of Supplementary notes 1 to 3,
wherein the information acquisition means acquires an object identification work time which is the time when the worker performed the object identification work of acquiring the object identification information, and,
wherein, in a case where object identification work is simultaneously performed on a plurality of objects by a plurality of workers at the object identification work time, the management means associates the work performed by each worker with the object identification information of the corresponding object.

### Supplementary note 5

The work management device according to any one of Supplementary notes 1 to 3,
wherein the information acquisition means acquires an object identification work time that is the time when the worker performed the object identification work of acquiring the object identification information, and,
wherein, in a case where object identification work is simultaneously performed on a plurality of objects by a plurality of workers at the object identification work time, the management means determines the work performed on each object based on identification information of each worker, the type of each object, or the position of each worker, and associates each of the determined work with the corresponding object.

### Supplementary note 6

The work management device according to any one of Supplementary notes 1 to 5,
wherein the management means stores the work record in a storage unit, and
wherein the work management device further comprises:
a work record acquisition means configured to acquire object identification information of an object and acquire a work record corresponding to the object identification information from the storage unit; and
a work history output means configured to output a work history indicating a work performed on the object based on the work record.

### Supplementary note 7

The work management device according to Supplementary note 6, further comprising a video output means configured to extract a video for a period corresponding to the work included in the work history from the video data and outputting the video.

### Supplementary note 8

A work management system comprising:
the work management device according to any one of Supplementary notes 1 to 7; and
a terminal device for the worker to read the object identification information from the object as the object identification work,
wherein the information acquisition means acquires the object identification information from the terminal device.

### Supplementary note 9

A work management method executed by a computer, comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data; and
creating a work record in which the work performed on the object is associated with the object identification information of the object, based on the object identification work included in the work detected from the video data.

### Supplementary note 10

A program that causes a computer to execute processing comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data; and
creating a work record in which the work performed on the object is associated with the object identification information of the object, based on the object identification work included in the work detected from the video data.

Some or all of the configurations described in Supplementary notes 2 to 8 dependent on the above-described Supplementary note 1 can also be dependent on Supplementary notes 9 and 10 by the same dependency relationship as in Supplementary notes 2 to 8. Some or all of the configurations described as Supplementary notes can be similarly dependent on not only Supplementary notes 1, 9, and 10, but also various pieces of hardware and software, and various recording means or systems for recording software without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 Work management system

5 Camera

7 Terminal

11 Processor

21 Video data storage unit

22 Person detection unit

23 Tracking unit

24 Work recognition unit

25 Work information generation unit

26 Video data extraction unit

27 Display unit

30 Object management unit

31 Comparison unit

32 Object identification information storage unit

33 Work record generation unit

34 Work record storage unit

35 Display control unit

100, 100x Work management device

1. A work management device comprising:
a memory configured to store instructions; and
a processor configured to execute the instructions to:
acquire video data obtained by capturing a work area in which a plurality of workers are present;
acquire object identification information for identifying an object on which work is performed, the object identification information being acquired by a worker performing object identification work;
detect work performed by each worker from the video data; and
create a work record in which the work performed on the object is associated with the object identification information of the object, based on the object identification work included in the work detected from the video data.

2. The work management device according to claim 1, wherein the processor associates, from the work detected from the video data, work performed on the object in a period between a start-time object identification work performed at a start of intended work on the object and an end-time object identification work
performed at an end of the intended work with the object identification information of the object.

3. The work management device according to claim 2
wherein the processor acquires a first object identification work time that is
a time at which the worker performed the object identification work at the start of the intended work and a second object identification work time that is a time at which the worker performed the object identification work at the end of the intended work, and
wherein the processor associates a work performed on the object between the start-time object identification work performed at a time that matches the first
object identification work time and the end-time object identification work performed at a time that matches the second object identification work time with the
object identification information of the object.

4. The work management device according to claim 1
wherein the processor acquires an object identification work time which is
the time when the worker performed the object identification work of acquiring the object identification information, and,
wherein, in a case where object identification work is simultaneously performed on a plurality of objects by a plurality of workers at the object identification work time, the processor associates the work performed by each worker with the object identification information of the corresponding object.

5. The work management device according to claim 1,
wherein the processor acquires an object identification work time that is the
time when the worker performed the object identification work of acquiring the
object identification information, and,
wherein, in a case where object identification work is simultaneously performed on a plurality of objects by a plurality of workers at the object
identification work time, the processor determines the work performed on each object based on identification information of each worker, the type of each object, or the position of each worker, and associates each of the determined work with the corresponding object.

6. The work management device according to claim 1,
wherein the processor stores the work record in a storage unit, and
wherein the processor is further configured to execute the instructions to::
acquire object identification information of an object and acquire a work record corresponding to the object identification information from the storage unit;
and
output a work history indicating a work performed on the object based on
the work record.

7. The work management device according to claim 6, wherein the processor is
further configured to execute the instructions to extract a video for a period corresponding to the work included in the work history from the video data and outputting the video.

8. A work management system comprising:
the work management device according to claim 1; and
a terminal device for the worker to read the object identification information from the object as the object identification work,
wherein the processor acquires the object identification information from the terminal device.

9. A work management method executed by a computer, comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data;and
creating a work record in which the work performed on the object is associated with the object identification information of the object, based on the object identification work included in the work detected from the video data.

10. A non-transitory computer-readable recording medium storing a program that causes a computer to execute processing comprising:
acquiring video data obtained by capturing a work area in which a plurality of workers are present;
acquiring object identification information for identifying an object on which work is performed, the object identification information being acquired by a worker performing object identification work;
detecting work performed by each worker from the video data; and
creating a work record in which the work performed on the object is associated with the object identification information of the object, based on the object
identification work included in the work detected from the video data.
